(19) United States
(12) Patent Application Publication
(10) Pub. No.: US 2007/0192231 A1
(43) Pub. Date: Aug. 16, 2007

(54) Method and system for calculating bids in an auction

(76) Inventor: John Matthew Farson, Charlotte, NC (US)

Correspondence Address: NELSON MULLINS RILEY & SCARBOROUGH, LLP, 1320 MAIN STREET, 17TH FLOOR, COLUMBIA, SC, 29201, US

(21) Appl. No.: 11/354,887

(22) Filed: Feb. 15, 2006

(51) Int. Cl. G06Q 40/00

(52) U.S. Cl. 705/37

(57) ABSTRACT

A method of conducting an auction includes positioning a first processor capable of at least calculating bids, determining winning scenarios in an auction, and accepting bids in a location in which the auction is being conducted. The method further includes positioning at least one bid query processor capable of at least calculating bids and determining winning bid scenarios in a location that is accessible to bidders and apart from the first processor. The first processor and the bid processor are preferably in electronic communication with one another such that the bid query processor is capable of accessing information stored in the first processor and determining new winning scenarios based on the information stored. The method further includes providing at least one bidder access to the at least one bid query processor such that the at least one bidder may determine a winning bid query before placing a bid, and accepting bids at the first processor.

### BACKGROUND OF THE INVENTION

The invention relates to the field of auctions. More specifically, the invention relates to the field of combinatorial auctions.

Auctions are known in the art as an efficient way to sell property, goods, and services. Three common types of auctions are forward auctions, reverse auctions, and sealed bid auctions. In recent years, combinatorial auctions have become a popular method of selling more than one unit of goods, real estate, services, natural resources, and the like, as well as combinations thereof.

In a combinatorial auction, a bid may be placed for a single unit, or a bid may be placed for a bundle of units. An auctioneer, or auction coordinator, selling properties wishes to maximize the value obtained through the auction of the properties for the seller. Bidders may have a willingness to exchange more value for combinations of properties than they would for individual elements of the combination, if considered alone and aggregated. For example, if A, B, C, D, and E were adjacent parcels of land along the bank of a river, and a bidder had a willingness to pay P1 for parcel A alone, P2 for parcel B alone, and P3 for parcel C alone, the bidder may have a greater willingness to pay more for the combination of the three adjacent parcels than P1+P2+P3. The bidder may also be willing to pay more for the assurance that all parcels will be won.

To the auctioneer, it is then desirable to structure an auction to allow a bidder to bid in any combination to gain the value of their synergies. This open-forum bidding procedure even allows overlapping combinations (i.e., A, B, and C; or B, C, and D; or A, C, and D, etc.) This is obviously desirable for bidders to be able to bid on combinations. Otherwise, bidders may risk overbidding or paying more than they would like for one of the properties/items to obtain the same combination of properties when a combinatorial auction format is unavailable. In some of the more complicated combinatorial auctions, it is also beneficial to allow successful bidders on the initial bidding of individual parcels (A, B, C, etc.) to regain their winning position if the desired individual parcel is placed in a combination by another bidder. This is accomplished by allowing any bidder to increase their initial bid if their desired parcel is placed in a combination. Additionally, because an auction may have many units (i.e., in excess of 100) resulting in thousands of potential combinations and potential winning scenarios, bidders often suffer from confusion regarding the current winning scenarios and the bid query necessary to achieve a winning position with respect to a bidder's desired unit/units.

Winner determination in combinatorial auctions means choosing which bids to accept so as to maximize the sum of the prices of the accepted bids. Computer programs capable of determining winners of combinatorial auctions are known in the art.

Combinatorial auctions are often conducted in large rooms, (e.g., hotel meeting rooms), where the progress of the auction can be difficult to follow. The auctioneer's assistant enters all new bids into a computer, often located at the front of a room, and the resulting “best combinations” from the new bids are calculated by the combinatorial auction program. Bidders must then follow the progress of the auction and determine when a new bid is necessary to achieve a winning position with respect to the desired individual item or a combination of items.

During an auction, the auctioneer has a plurality of responsibilities including, but not limited to, acknowledging new bids, either on the floor of the auction facility or via the internet; maintaining the first processor such that the auction may continue; and broadcasting the current results of the auction.

This is especially true when the auction is a combinatorial auction. With potentially thousands, if not millions, of combinations that may be bid upon, the speed of a combinatorial auction may be very fast. Bidders may not have time to determine the value necessary to achieve a new winning position before that value changes due to other entered bids. Moreover, bidders often face the difficulty of needing to determine values such as different price per acre values for different combinations, depending on the combinations present in the current winning scenario.

Bidders are often confused by the difficulty in determining new bid queries. Previous methods to overcome this confusion have included asking the auction coordinator for guidance in determining new bid queries. This method often results in auction delays because the auction coordinator is utilizing the processor to determine current winning bid queries rather than entering new bids. Additionally, bidders may find it difficult to maintain anonymity if all of the bidders must approach the auction coordinator or assistant. All of this could be a major disruption to the sale, resulting in confusion and turmoil.

Many auction coordinators have begun utilizing bidding assistants in an attempt to overcome these problems. Bidding assistants work with bidders to determine the desired combinations, then approach the auction coordinator to determine what bid would be necessary to place the interested bidder in a new winning position. This method does help in minimizing confusion and aids in overcoming the difficulty in maintaining anonymity; however, it does not decrease the distractions facing the auction coordinator, because it is simply a different group of people crowding around the auction coordinator waiting to get the “correct answer.”

Additionally, this method creates other unique problems. In the time it may take a bidding assistant to determine a desired combination, approach the auction coordinator to determine the amount necessary to place the interested bidder in a winning position, return to the interested bidder and inform the interested bidder of the necessary bid query, attain the bidders permission to place the new bid, and return to the auction coordinator to place the bid, that bid query may no longer be accurate. Stated differently, if it takes too long to determine a necessary bid query, the auction may have moved on and the calculation is no longer accurate due to the placement of additional bids.

### SUMMARY OF THE INVENTION

In one aspect the invention is a method of conducting an auction. The method includes positioning a first processor capable of at least calculating bids, determining winning scenarios in an auction, and accepting bids in a location in which the auction is being conducted. The method further includes positioning at least one bid query processor capable of at least calculating bids and determining winning bid scenarios in a location that is accessible to bidders and apart from the first processor. The first processor and the bid query processor are preferably in electronic communication with one another such that the bid query processor is capable of accessing information stored in the first processor and determining new winning scenarios based on the information stored. The method further includes providing at least one bidder access to the at least one bid query processor such that the at least one bidder may determine a winning bid query before placing a bid, and accepting bids at the first processor.

In another aspect, the invention is a system for efficiently calculating a new winning bid in a combinatorial auction. The system may include a first processor for accepting bids and conducting the combinatorial auction, at least one bid query processor, in a location remote from said first processor, for calculating winning scenarios. In an exemplary embodiment, information regarding the progress of the auction is stored on the first processor and the bid query processor is capable of accessing the information stored on the first processor to calculate winning scenarios.

In yet another embodiment, the invention is a method of conducting an auction including positioning an auctioneer at a first processor and equipping at least one bidding assistant with a bid query processor in electronic communication with the first processor. The method further includes positioning the bidding assistant in a position remote from the first processor, wherein the bidding assistant utilizes the bid query processor to aid at least one potential bidder in determining a bid query that would place the bidder in a winning position. The bidding assistant, after assisting the potential bidder in determining a bid query that would place the bidder in a winning position, may then determine whether the potential bidder would like to place a bid and assist the potential bidder in placing the bid.

The foregoing, as well as other objectives and advantages of the invention and the manner in which the same are accomplished, is further discussed within the following detailed description and its accompanying drawings.

### BRIEF DESCRIPTION OF THE DRAWING

The present invention now will be described more fully hereinafter with reference to the accompanying drawing, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements.

FIG. 1 is a representative schematic map of an auction venue in which the method of the present invention may be conducted.

FIG. 2 is a representative depiction of a bid query processor in accordance with the present invention.

FIG. 3 is a representative information screen for a bid query processor in accordance with the present invention.

### DETAILED DESCRIPTION

The invention relates to a method and system for conducting auctions. More specifically, the invention relates to a method and system of providing access to bid query processors to enable potential bidders to determine the bid queries necessary to place a winning bid.

The present invention is not limited to land/real estate auctions, but may be utilized in auctions of any of the types of property (real or personal) and/or services capable of being offered for sale in an auction format. Non-limiting examples include auctions for real estate, personal property, services, natural resources, such as timber, water rights, mining rights, development rights, and the like, as well as combinations thereof. For example, auctions offering land and timber or other natural resources separately are contemplated. The invention is especially useful in scenarios where combination bids may be desirable. Because the items may be bid upon concurrently, rather than sequentially as in the traditional auction scenario, the invention enables potential bidders to more readily determine the bid queries necessary to achieve a winning position in the auction. The invention further facilitates concurrent bidding and combinatorial bidding by alleviating the uncertainty of necessary bid queries.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

For ease of discussion, the method and system will be described with reference to combinatorial auctions. Those having ordinary skill in the art will recognize that the invention is applicable to auctions having formats other than the format of combinatorial auctions, and shall not be so limited. Similarly, the method will be described with respect to land auctions for ease of discussion. Those having ordinary skill in the art will recognize that the invention is applicable to auctions of other items, such as personal property and natural resources, and shall not be so limited.

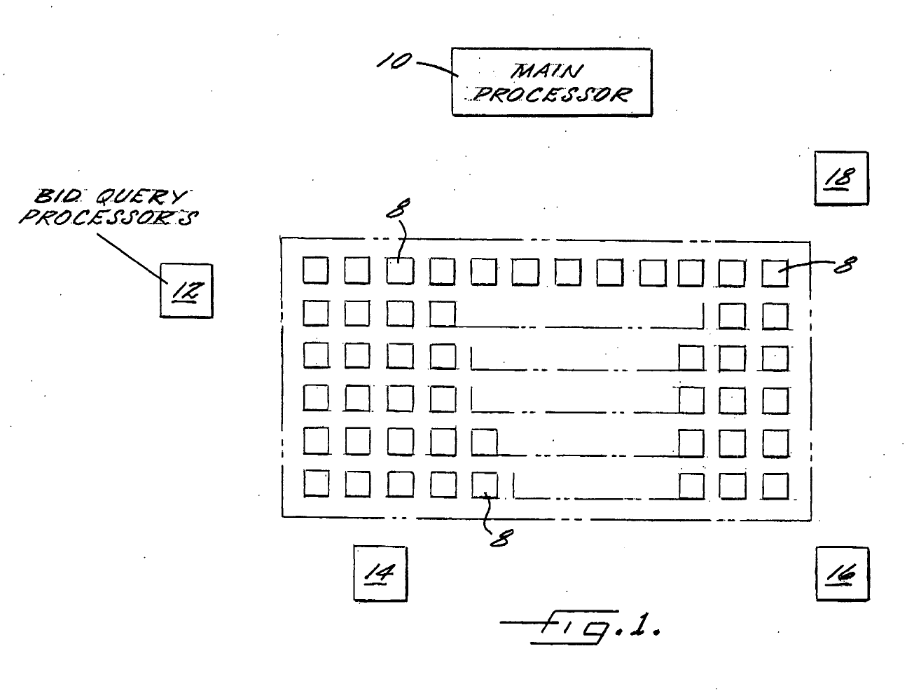

In one aspect, the invention is a system for efficiently calculating a new winning bid in a combinatorial auction. The system may be located in a location, such as a room, where an auction is to be conducted, as depicted in FIG. 1. The room may also include other amenities useful when conducting an auction, such as chairs 8, as well as a podium (not shown), refreshments (not shown), combinations thereof, and the like.

The system may include a first (or main) processor 10 for accepting bids and conducting the combinatorial auction. The first processor 10 may also include information relating to one or more of a current winning scenario in the auction, past winning scenarios, the current price per unit, past prices per unit, the number of bidders, the number of bids, the identity of bidders and potential bidders, combinations thereof, and the like.

The system further includes at least one bid query processor 12. The system may include more than one bid query processor 14, 16, 18, for example, 2, 3, 4, 5, 6, 7, or more bid query processors 12, 14, 16, 18. Those having ordinary skill in the art will recognize that references to the “bid query processor,” the “at least one bid query processor,” and “one or more bid query processor” shall be understood as being interchangeable for the purposes of the present invention unless explicitly stated otherwise.

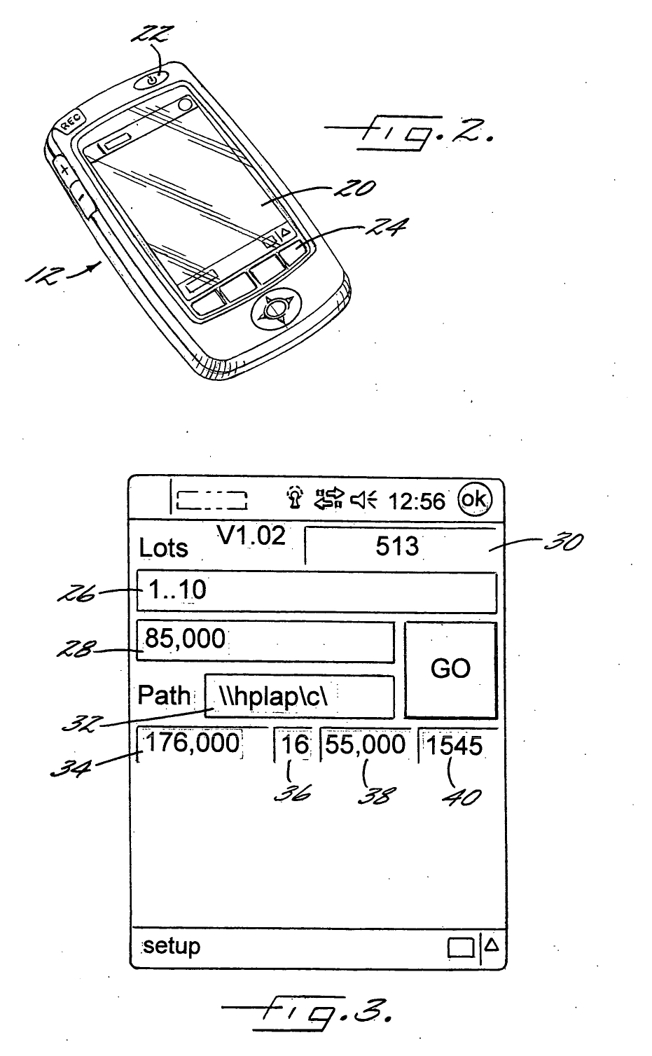

In an exemplary embodiment, the bid query processor 12 is in a location remote from the first processor 10. For example, the bid query processor 12 may be in one or more of the same room as the first processor 10 but in a different location than the first processor 10 (as depicted in FIG. 1), in a different room than the first processor 10, in a different building than the first processor 10, combinations thereof, and the like. The at least one bid query processor 12 may be one or more of a handheld computing device (i.e., a personal data assistant) as depicted in FIG. 2, a laptop computer, a desktop-style computer, combinations thereof, and the like.

The bid query processor 12 may include a screen 20, a power controller 22, and means for data entry 24. As depicted in FIG. 2, the bid query processor 12 may be a personal data assistant. Those having ordinary skill in the art will recognize that the means for data entry 12 may be one or more of a stylus for entering information on a PDA, a keyboard, dictation software, and other means known in the art for entering data into a computing device.

In an exemplary embodiment, the at least one bid query processor 12 is capable of calculating winning scenarios in a combinatorial auction. In another embodiment, the bid query processor 12 is capable of accessing information stored at the first processor 10. For example, the bid query processor may be able to access information stored at the first processor 10, such as one or more of the current winning scenario, past winning scenarios, the current price per unit, past prices per unit, the number of bidders, the number of bids, the identity of bidders and potential bidders taking part in the auction, combinations thereof, and the like.

In one embodiment, the at least one bid query processor 12 and the first processor 10 are in electronic communication with one another. The at least one bid query processor 12 and the first processor 10 may be physically connected to one another, may be in wireless communication with one another, combinations thereof, and the like. In an exemplary embodiment, the bid query processor 12 and the first processor 10 may be in direct communication, i.e., over an intranet connection; in indirect communication, i.e., over an internet connection; combinations thereof, and the like.

In another aspect, the invention is a method of conducting an auction. The method may include positioning a first processor in a location, such as a room, in which an auction is being conducted. In an exemplary embodiment, the processor is capable of at least calculating bids, determining winning scenarios in an auction, and accepting bids. The first processor may also be capable of determining price per unit values in a winning scenario. Additionally, the first processor may be capable of calculating the number of units in a winning scenario. In one embodiment, the first processor is capable of accepting bids in the auction.

The method further includes positioning at least one bid query processor in a location that is accessible to bidders and apart from the first processor. In an exemplary embodiment, more than one bid query processor may be utilized.

In another exemplary embodiment, the step of positioning the bid query processor(s) in a location that is apart from the first processor may include one or more of positioning the bid query processor(s) in the same room as the first processor or in a different room than the first processor. Similarly, the bid query processor(s) may be positioned in a facility separate from the first processor.

In an exemplary embodiment, the bid query processor and the first processor are in electronic communication with one another such that the bid query processor is capable of accessing information stored at or in the first processor and determining new winning scenarios based on the information stored in the first processor. For example, in this embodiment, a bidding assistant may enter a desired combination into the bid query processor. The bid query processor may then communicate with the first processor to determine the value of the current winning scenario. After determining the value of the current winning scenario, the bid query processor may then calculate the bid query necessary to achieve a new winning position for the desired combination.

In another exemplary embodiment, the bid query processor and the first processor are in electronic communication with one another such that the bid query processor may request information, such as a winning scenario, from the first processor. For example, in this embodiment, a bidding assistant may enter a desired combination into the bid query processor. The bid query processor may then communicate the desired combination to the first processor. The first processor may then communicate the amount necessary to achieve a winning position back to the bid query processor.

The at least one bid query processor and the first processor may be physically connected to one another. Alternatively, the at least one bid query processor and the first processor may be in wireless communication with one another. In yet another embodiment, the at least one bid query processor and the first processor may be connected via an internet connection. Other methods known in the art for effecting electronic communication between the processors are also contemplated as useful in the present invention.

In yet another embodiment, the bid query processor may be one or more of a hand-held computing device, such as a personal data assistant (PDA); a laptop computer, a desktop computer, combinations thereof, and the like.

In one embodiment, the method includes providing at least one potential bidder access to the at least one bid query processor such that the at least one bidder may determine a winning bid query before placing a bid. Stated differently, a potential bidder may utilize a bid query processor to determine, for example, the necessary value of a bid that would place the bidder in a winning position with respect to desired item(s) being auctioned.

In an exemplary embodiment, a bidding assistant may aid a potential bidder in utilizing the present bid query processors. In this embodiment, for example, a potential bidder may inform a bidding assistant of the desired item(s). The bidding assistant may then enter the identity of the desired item(s) into the bid query processor. As depicted in FIG. 3, the bidding assistant may enter the desired combination of units (identified in the Figure as lots) into the query box 26. The bid query processor may then inform the bidding assistant of the necessary bid to place the bidder in a winning position with respect to the desired item(s). The amount of the bid necessary to place a bidder in a winning position with respect to the desired combination may then be displayed in the bid query box 28.

Other information that may be included at the bid query processor include one or more of the auction identity 30, the wireless connection path 32, the total amount of the current winning scenario 34, the number of available units in the auction 36, the number of acres represented in the auction 38, and the average price per unit (i.e., price per acre in a land auction) 40, combinations thereof, and the like. Those having ordinary skill in the art will recognize that additional information may be displayed on a screen of the bid query processor. The present specification shall be read and understood to include other relevant information known in the art.

In an exemplary embodiment, bids may be placed at the first processor. Alternatively, in some embodiments, bids may be accepted at one or more bid query processors. In yet another embodiment, bids may be placed at either the first processor or at one or more bid query processors.

The bids may be placed by one or more of an auction coordinator on behalf of a bidder, a bidding assistant on behalf of a bidder, by a bidder, by a bidder's representative, combinations thereof, and the like.

As used herein, the term “auction coordinator” is intended to represent the person, or persons, conducting the auction. For example, the auctioneer may be the auction coordinator. As is known to those having ordinary skill in the art, combinatorial auctions may be conducted without an auctioneer calling out the identity of particular items available for bidding. In these situations, the auction coordinator may be positioned at the first processor, but not at a podium announcing items as a traditional auctioneer. The specification shall be read and understood to include auction coordinators acting in capacities known in the art as useful for conducting auctions.

In yet another aspect, the invention is a method of conducting an auction. The method includes positioning an auction coordinator at a first processor and equipping at least one bidding assistant with a bid query processor in electronic communication with the first processor. The bidding assistant may be equipped with a bid query processor embodied in a hand held computing device (i.e., a PDA), a laptop computer, a desktop style computer, combinations thereof, and the like.

The method may further include positioning the bidding assistant in a position remote from said first processor. For example, the bidding assistant may be positioned in one or more of the same room as the first processor, but in a different location in the room than the first processor, a different room than the first processor, a different building than the first processor, combinations thereof, and the like.

In one embodiment, the first processor and the bid query processor may be positioned such that they are in electronic communication with one another. The first processor and the bid query processor may be in one or more of wired and wireless communication. Similarly, the first processor and the bid query processor may be in one or more of direct electronic communication, i.e., over an intranet connection; indirect communication, i.e., over an internet connection; combinations thereof; and the like.

In an embodiment of the present invention, a bidding assistant may aid at least one potential bidder in using the bid query processor to determine a bid query that would place the potential bidder in a winning position with respect to the desired item(s).

In one embodiment, the bidding assistant may place a bid for a bidder. This embodiment may enable a bidder to maintain anonymity. In another embodiment, a bidder may place a bid for herself. In some embodiments, a combination of the methods for placing a bid may be utilized.

The present method and system may enable a more efficient auction scenario. By utilizing the bid query processors, bidders and/or potential bidders may be better able to get accurate, real-time information regarding the bid queries necessary to place that bidder in a winning position with respect to the desired combination of items. The ability of the bid query processors to electronically interact with the first processor insures the accuracy and dependability of the bid queries being determined by the bid query processors.

The use of the bid query processors also substantially eliminates time lost due to the amount of time it may take to determine a bid query only to have that calculation become obsolete before completion due to the placement of a superseding bid.

Moreover, where anonymity is desired, the bid query processors may also be utilized to place bids. This ability would alleviate the necessity of a bidder, or a bidding assistant, from directly approaching the auction coordinator and/or the first processor to place a bid. Bidders may, therefore, maintain some level of anonymity with respect to who is actually placing bids.

In the specification, drawings, and example, there have been disclosed typical embodiments of the invention and, although specific terms have been employed, they have been used in a generic and descriptive sense only and not for purposes of limitation, the scope of the invention being set forth in the following claims.

1. A method of conducting an auction, the method comprising:
positioning a first processor capable of at least calculating bids, determining winning scenarios in an auction, and accepting bids in a location in which the auction is being conducted;
positioning at least one bid query processor capable of at least calculating bids and determining winning bid scenarios in a location that is accessible to bidders and apart from the first processor;
wherein said first processor and said at least one bid query processor are in electronic communication with one another such that the bid query processor is capable of accessing information stored in the first processor and determining new winning scenarios based on the information stored;
providing at least one bidder access to the at least one bid query processor such that the at least one bidder may determine a winning bid query before placing a bid; and
accepting bids at the first processor.

2. A method of conducting an auction according to claim 1, wherein the auction is a combinatorial auction.

3. A method of conducting an auction according to claim 1, wherein the step of accepting bids at the first processor further comprises accepting bids at the at least one bid query processor.

4. A method of conducting an auction according to claim 1, wherein the step of positioning at least one bid query processor comprises positioning more than one bid query processor.

5. A method of conducting an auction according to claim 1, wherein the first processor and the at least one bid query processor are physically connected.

6. A method of conducting an auction according to claim 1, wherein the first processor and the at least one bid query processor are connected via a wireless connection.

7. A method of conducting an auction according to claim 1, wherein the step of providing at least one bidder access to the at least one bid query processor comprises utilizing a bidding assistant to aid the at least one bidder.

8. A method of conducting an auction according to claim 1, wherein a bidder enters a bid into said first processor.

9. A method of conducting an auction according to claim 1, wherein a bidding assistant enters bids into said first processor.

10. A method of conducting an auction according to claim 1, wherein the first processor and the bid query processor are capable of calculating price per unit information in a winning scenario.

11. A method of conducting an auction according to claim 1, wherein said first processor and said bid query processor are capable of calculating the number of units in a winning scenario.

12. A method of conducting an auction according to claim 1, wherein the bid query processor is a hand-held computing device.

13. A method of conducting an auction according to claim 12, wherein the hand-held computing device is a personal data assistant (PDA).

14. A method of conducting an auction according to claim 1, wherein the bid query processor is a laptop computer.

15. A method of conducting an auction according to claim 1, wherein the bid query processor is a desktop-style computer.

16. A system for efficiently calculating a new winning bid in a combinatorial auction, the system comprising:
a first processor for accepting bids and conducting the combinatorial auction;
at least one bid query processor, in a location remote from said first processor, for calculating winning scenarios;
said first processor and said bid query processor being in electronic communication with one another;
wherein information regarding the progress of the auction is stored on said first processor; and
said bid query processor is capable of accessing said information stored on said first processor to calculate said winning scenarios.

17. A system according to claim 16, wherein said first processor is physically connected to said bid query processor.

18. A system according to claim 16, wherein said first processor and said bid query processor are in wireless communication.

19. A system according to claim 16, further comprising at least one additional bid query processor.

20. A system according to claim 16, wherein said bid query processor comprises a handheld computing device.

21. A system according to claim 20, wherein said handheld computing device comprises a personal data assistant (PDA).

22. A system according to claim 16, wherein said bid query processor comprises a laptop computer.

23. A system according to claim 16, wherein said bid query processor comprises a desktop style computer.

24. A system according to claim 16, wherein said bid query processor is in the same room as said first processor.

25. A system according to claim 16, wherein said bid query processor is in a different room than said first processor.

26. A system according to claim 16, wherein said first processor and said bid query processor are in direct electronic communication.

27. A system according to claim 16, wherein said first processor and said bid query processor are in electronic communication over the internet.

28. A system according to claim 16 wherein said information includes one or more of the current winning scenario, past winning scenarios, the current price per unit, past prices per unit, the number of bidders, the number of bids, and the identity of bidders and potential bidders in the auction.

29. A method of conducting an auction comprising:
positioning an auctioneer at a first processor;
equipping at least one bidding assistant with a bid query processor in electronic communication with the first processor;
positioning the bidding assistant in a position remote from said first processor, wherein said bidding assistant utilizes the bid query processor to aid at least one potential bidder in determining a bid query that would place the bidder in a winning position; and
wherein the bidding assistant, after assisting the potential bidder in determining a bid query that would place the bidder in a winning position, determines whether the potential bidder would like to place a bid and assists the potential bidder in placing the bid.

30. A method according to claim 29, wherein the step of equipping at least one bidding assistant with a bid query processor comprises equipping at least one bidding assistant with a handheld computing device in electronic communication with the first processor.

31. A method according to claim 29, wherein the step of equipping at least one bidding assistant with a bid query processor comprises equipping at least one bidding assistant with a bid query processor in wired communication with the first processor.

32. A method according to claim 29, wherein the step of equipping at least one bidding assistant with a bid query processor comprises equipping at least one bidding assistant with a bid query processor in wireless communication with the first processor.

33. A method according to claim 29, wherein the step of positioning a bidding assistant in a position remote from the first processor comprises positioning the bidding assistant in the same room as the first processor.

34. A method according to claim 29, wherein the step of positioning a bidding assistant in a position remote from the first processor comprises positioning the bidding assistant in a different room than the first processor.

35. A method according to claim 29, wherein the step of assisting the potential bidder in placing a bid comprises placing the bid for the bidder to enable the bidder to maintain anonymity.

36. A method according to claim 29, wherein the step of assisting the potential bidder in placing a bid comprises placing a bid at the first processor.

37. A method according to claim 29, wherein the step of assisting the potential bidder in placing a bid comprises placing a bid at the bid query processor.
